(19) United States
(12) Patent Application Publication
(10) Pub. No.: US 2024/0404747 A1
(43) Pub. Date: Dec. 5, 2024

(54) INJECTION MOLDED INDUCTIVE APPARATUS, POWDER MAGNETIC CORE, AND INJECTION MOLDING METHOD

(71) Applicant: EAGLERISE INTELLIGENT DEVICE CORPORATION LTD., Foshan, Guangdong (CN)

(72) Inventors: Kakuryo Sho, Foshan, Guangdong (CN); Bo Zhang, Foshan, Guangdong (CN)

(21) Appl. No.: 18/699,898

(22) PCT Filed: Oct. 15, 2021
(86) PCT No.: PCT/CN2021/124077

§ 371 Date: Apr. 10, 2024

(51) Int. Cl. H01F 27/30; B29C 45/14; B29L 31/34; H01F 27/255; H01F 27/26; H01F 41/02

(52) U.S. Cl. CPC H01F 27/306; B29C 45/14639; H01F 27/255; H01F 27/263; H01F 41/0246; B29L 2031/34

(57) ABSTRACT

An injection molded inductive apparatus, a powder magnetic core, and an injection molding method. The inductive apparatus comprises a magnetic core, a coil, and an injection molding body; the magnetic core is of an annular structure and is provided with two winding portions; one or more grooves are formed on the winding portions; the coil is wound on each winding portion, and an injection molding channel is formed between the inner side surface of the coil and the groove on the winding portion; and the injection molding body is filled along the injection molding channel, and constitutes an integrally molded body together with the magnetic core and the coil. According to the apparatus, one or more grooves are designed on the winding portions of the magnetic core, and the compact filling effect of the injection molding body in a gap between the coil and the magnetic core is achieved.

### TECHNICAL FIELD

The present disclosure relates to inductance, in particular to injection molded inductive apparatus, powder magnetic cores and injection molding methods.

### BACKGROUND

New energy vehicles and hybrid vehicles characterized by automobile electrification are gradually replacing traditional oil-fueled vehicles, which is becoming an important means for countries to address the greenhouse effect of climate change at present. The core of automobile electrification is to achieve efficient electromechanical coupling in the course of driving through power battery energy storage and motor drive, thereby saving fuel or completely eliminating the use of fuel. In the operating mechanism of automobile electrification, high-power voltage conversion of high-voltage electric energy is a significant feature of charging a battery and discharging a battery to drive a motor. Accordingly, high-power inductive components in conversion circuits become essential and important core components.

In order to meet service conditions and requirements of ultra-wide temperature range, harsh mechanical vibration and shock, high-voltage insulation, high-power heat dissipation for vehicles, vehicle-mounted high-power inductors are often produced by one-piece injection molding with using engineering plastics such as PPS having good heat resistance, insulation, thermal conductivity, resistance to thermal shock like high and low temperature, oil resistance, and extremely high mechanical strength. This can greatly improve the energy storage density of a high-power inductive component. It is necessary in practice to minimize the size of an inductive coil and the size of the internal cavity of an inductive coil winding, such as making the coil winding slightly larger than the outer contour of the cross section of the magnetic core inside the coil, so as to reduce the copper consumption and the resistance of the copper wire of the inductive component while maintaining the same cross-section of the wire.

Based on the structure of a current high-power inductive component, a gap of only about 0.5˜3 mm is allowed between the magnetic core inside the coil and the coil in design. In this connection, during the one-piece injection molding, such a narrow gap will lead to poor fluidity of high-temperature melts of engineering plastics such as PPS; accordingly, it is difficult to fully fill the gap. In addition, in order to improve the filling of the gap between the magnetic core and the coil, higher injection pressure will be used to enhance the fluidity. However, the increase of the injection pressure will cause a series of problems such as increased wear of molds and fragmentation of the magnetic core.

### SUMMARY OF THE INVENTION

### Technical Problem

The present disclosure is aimed to how to improve injection performance of high-power inductors in the process of one-piece injection molding.

### Solution of the Problem

### Technical Solution

To achieve the above purpose, an injection molded inductive apparatus, a powder magnetic core, and an injection molding method are proposed in the present disclosure.

In accordance with a first aspect of the present disclosure, an injection molded inductive apparatus provided in some embodiments may include: a magnetic core, a coil and an injection molding body; wherein, the magnetic core may be of an annular structure and be provided with two winding portions having one or more grooves; the coil may be wound on the winding portions, and injection molding channels may be formed between the inner side of the coil and the groove(s) of the winding portions; and the injection molding body may be filled in the injection molding channels and may constitute an integrally molded body together with the magnetic core and the coil.

The groove(s) on the winding portions may be extended to at least one end of the winding portions, and the grooves may extend beyond the coverage of the coil on the winding portions.

The groove(s) may be extended on the winding portions in a vertical or curved manner, and the cross section of the groove(s) may be trapezoidal, arc or square.

The depth of the groove(s) may be ranged between 1 mm and 5 mm and the width of the groove(s) may be ranged between 3 mm and 15 mm; and a preset percentage of the area of any cross section of the winding portions may be greater than the area of the cross section of the one or more grooves.

The magnetic core may include two first components and a plurality of second components; the two first components may be arranged opposite to each other, the second components may be arranged in rows in parallel and between the two first components, all the first components and the second components may be combined to form the annular structure of the magnetic core; and the second components may be used as the winding portions.

The first components each may have a U-shaped opening; and the second components may be arranged in two rows in parallel and between two oppositely-arranged openings of the first components.

The outer side surface of the second components may include one or more geometric surfaces, a plurality of the geometric surfaces may be provided with the groove(s).

The inductive apparatus may also include a plurality of fixed brackets that may be fixedly around the first components and may be provided with clamping components; and the inner side of the clamping components may clamp the second components and the outer side of the clamping components may carry the coil.

Injection molding gaps may be formed between the inner side of the coil and the outer side of the second components, a gap distance of the injection molding gaps may be ranged between 0.5 mm and 3 mm; and the injection molding body may be expanded to the surrounding injection molding gaps along the injection molding channels to fill the injection molding channels and the injection molding gaps.

The groove(s) on the winding portions may be extended to the outer side of the first components, an injection molding inlet may be formed between the groove(s) on the first components and the fixed brackets fixedly therearound; the injection molding inlet may be communicated with the injection molding channels, and the injection molding body may be formed by injecting plastic melt into the injection molding channels through the injection molding inlet.

The injection molding body may wrap the first components, forming assembly parts on the periphery of the first components; and the assembly parts may be configured to install and fix an integrally molded body formed by the injection molding body, the magnetic core and the coil.

The assembly parts may be provided with a plurality of through holes configured to pass through screws or bolts used for installation and fixation.

The assembly parts may also be provided with a flat wire that may be connected with a terminal of the coil to introduce or lead out direct current to the coil.

According to a second aspect of the present disclosure, a combined powder magnetic core comprising two first components and a plurality of second components is provided in some embodiments. The two first components may be arranged opposite to each other; the plurality of second components may be arranged in two rows in parallel and between the two first components, the second components may form as winding portions provided with one or more grooves; the winding portions may be configured to be wound by a coil, the inner side of the coil and the groove(s) on the winding portions may form an injection molding channel; and all the first components and the second components may be combined to form an annular structure which may generate an electromagnetic loop when the coil is energized.

The groove(s) on the winding portions may be extended to at least one end of the winding portions and extended beyond the coverage of the coil on the winding portions.

The second components may be provided with fixing parts used to clamp the first components; the groove(s) on the winding portions of the second components may be extended onto the first components, an injection molding inlet may be formed between the groove(s) on the first components and the fixed brackets fixedly therearound; the injection molding inlet may be connected with the injection molding channels, the plastic melt may be injected to the injection molding channels through the injection molding inlet to form the injection molding body.

The first components and the second components may be made of materials of metal powder, and may be made of pressed metal powder.

According to a third aspect of the present disclosure, an injection molding method provided in some embodiments may include: providing a magnetic core, a plurality of coils and an injection mold, the magnetic core being of an annular structure and provided with two winding portions provided with one or more grooves; winding the coils onto the winding portions so that an injection molding channel is formed between an inner side of the coils and the grooves on the winding portions; arranging the magnetic core surrounded by the coils in the injection mold; injecting plastic melt into the injection mold so as to fill the plastic melt along the injection molding channel; and cooling the plastic melt in the injection mold to form an injection molding body that is capable of forming an integrally molded body together with the magnetic core and the coils.

The magnetic core may comprise two first components and a plurality of second components; the two first components may be arranged opposite to each other, the plurality of second components may be arranged in two rows in parallel between the two first components, all the first components and the second components may be combined to form an annular structure of the magnetic core; the second components are used as the winding portions; the first components may be surrounded by and fixed with fixed brackets provided with clamping components, an inner side of the clamping components may clamp the second components and an outer side of the clamping components may carry the coils; an inner side of the coils and an outer side of the second components may form injection molding gaps; and during the plastic melt injecting into the injection mold, the plastic melt may be expanded in the injection molding channel to the injection molding gaps therearound until the injection molding channel and the injection molding gaps are filled.

### Effect of the Invention

### Beneficial Effect

The beneficial effects of the present disclosure are as follows:

According to the injection molded inductive apparatus, the powder magnetic core and the injection molding method disclosed in the above embodiments, the inductive apparatus comprises a magnetic core, a coil and an injection molding body, the magnetic core is of an annular structure and has two winding portions which are provided with one or more grooves; the coil is wound on the winding portions, an injection molding channel is formed between the inner side of the coil and the groove(s) on the winding portions; the injection molding body may be filled in the injection molding channel to form an integrally molded body together with the magnetic core and the coil. Firstly, by designing one or more grooves on the winding portions of the magnetic core, the injection molding channel formed on the groove(s) can improve the fluency of the injection of high-temperature plastic melt flowing into the inner side of the coil, reduce the injection molding pressure, and achieve the compact filling effect of the injection molding body in the gaps between the coil and the magnetic core while decreasing the pressure of two yoke magnetic cores to prevent the magnetic core from cracking. Secondly, an injection molding channel is formed between the coil and the magnetic core, only a lower injection molding pressure can be provided while the inductance characteristics and the magnetic flux density are changed insignificantly, thus completing the filling of the thin gap between the coils and the magnetic core to improve the injection performance of the integrated inductor. Thirdly, the integrally molded body formed by the magnetic core, the coils and the injection molding body can minimize the spacial distance between the coil and the magnetic core to ensure good electrical insulation, and the extremely thin insulation distance can also improve the outward heat conduction characteristics of the magnetic core, and the compact injection molding effect can ensure the overall resistance to mechanical vibration and impact of the inductance. Fourthly, the inductance apparatus based on the integrally molded body can have the advantages of small size and light weight, can significantly improve the energy storage sensitivity density of high-power inductors, and significantly reduce the material cost of components.

### BRIEF DESCRIPTION OF THE DRAWINGS

### Description of Drawings

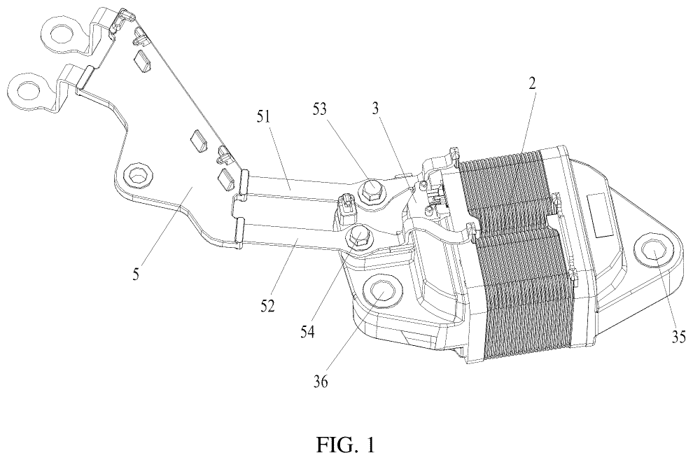

FIG. 1 is an overall structure diagram of an injection molded inductive apparatus in some embodiments of the present disclosure;

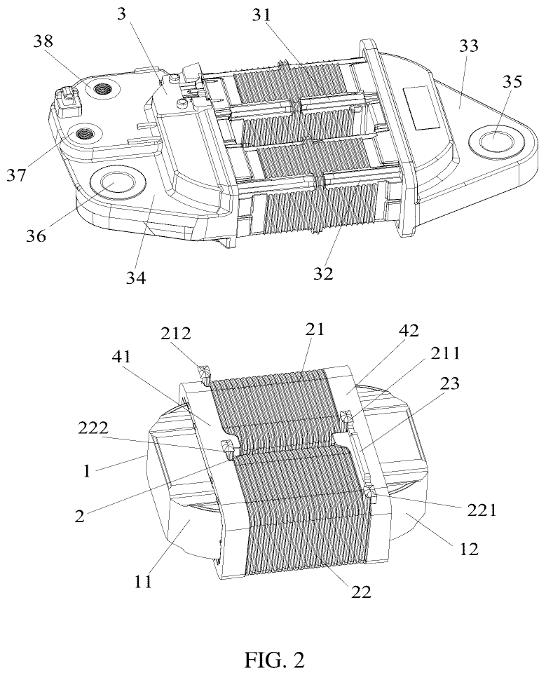

FIG. 2 is a structure diagram of a magnetic core, coils and an injection molding body in some embodiments;

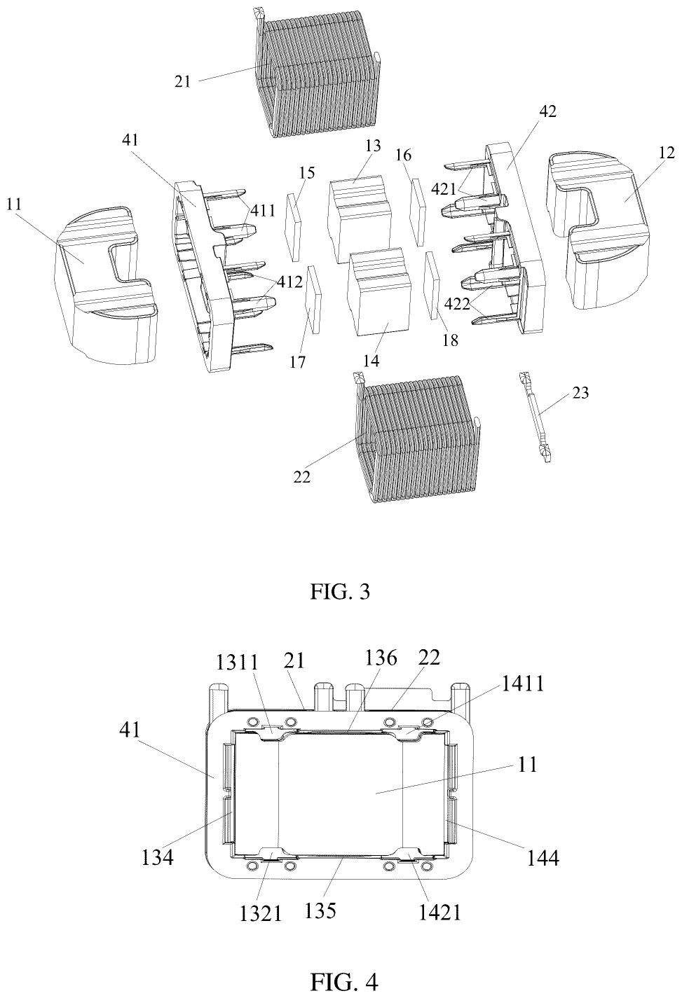

FIG. 3 is an explosion diagram of a magnetic core and coils in some embodiments;

FIG. 4 is a side view of a magnetic core and a coil in some embodiments;

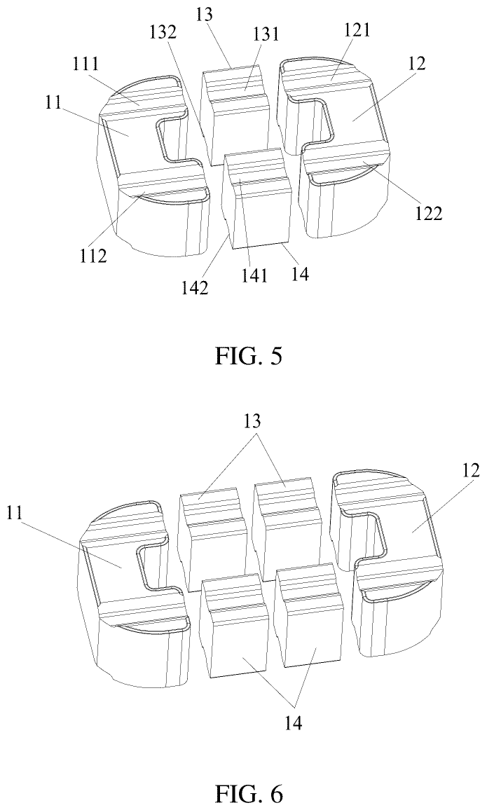

FIG. 5 is a structure diagram of a magnetic core in some embodiments;

FIG. 6 is a structure of a magnetic core in other embodiments;

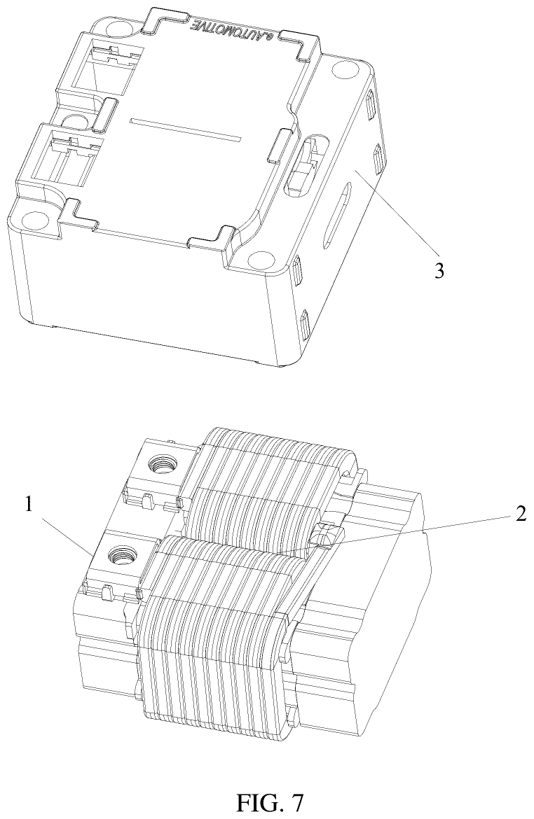

FIG. 7 is a structure diagram of an injection molded inductive apparatus in other embodiments of the present disclosure;

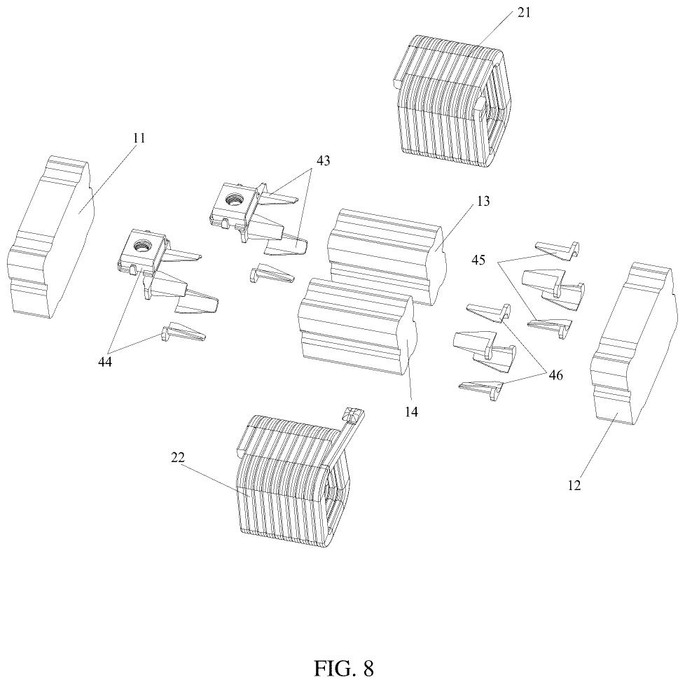

FIG. 8 is an explosion diagram of a magnetic core and a coil in other embodiments;

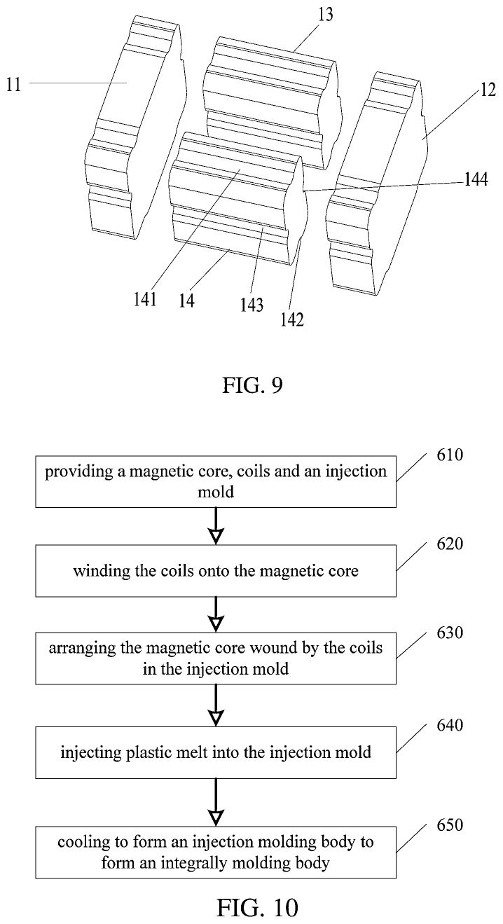

FIG. 9 is a structure diagram of a magnetic core in other embodiments; and

FIG. 10 is a flowchart of an injection molding method in some embodiments of the present disclosure.

### EMBODIMENTS OF THE INVENTION

### Examples of the Invention

The present disclosure is further described in detail below through specific embodiments in combination with the drawings, wherein, similar elements in different embodiments adopt associated similar element labels. In the following embodiments, many details are described in order to make the application be better understood. However, those skilled in the art can easily realize that some features can be omitted in different cases or can be replaced by other elements, materials and methods. In some cases, some operations related to the present disclosure are not shown or described in the specification in order to avoid the core part of the present disclosure being overwhelmed by excessive descriptions, and for those skilled in the art, it is not necessary to describe these relevant operations in detail, they can completely understand the relevant operations according to the description in the specification and the general technical knowledge of the field.

In addition, the features, operations or characteristics described in the specification may be combined in any appropriate manner to form various embodiments. At the same time, the steps or actions described in the method may be sequenced or adjusted in a manner apparent to those skilled in the art. Therefore, the sequences in the specification and the drawings are intended to clearly describe an embodiment and are not meant to be a required sequence unless it is indicated otherwise that a sequence must be followed.

The serial numbers assigned to the parts in the present disclosure, such as “first”, “second”, etc., are only used to distinguish the described objects, and do not have any sequential or technical meaning. The terms “connect” and “couple” as mentioned in the present disclosure, unless otherwise specified, include direct and indirect connection (coupling).

### Embodiment 1

Referring to FIGS. 1-5, an injection molded inductive apparatus in this embodiment may mainly include a magnetic core 1, a coil 2 and an injection molding body 3, which will be explained below.

The magnetic core 1 may be of an annular structure provided with two winding portions. Each winding portion may be provided with one or more grooves. The annular structure of the magnetic core I may be a closed ring, or an incomplete closed ring obtained by combining a plurality of components. It is preferable to take at least one component required for combination to obtain the winding portions so as to facilitate winding on the winding portions. In addition, since each winding portion needs to be wound by the coil 2 and the magnetic core I needs to generate an electromagnetic loop when the coil 2 are energized, it is preferable to provide the winding portions on the opposite sides of the annular structure respectively, so that the generated electromagnetic loop can be evenly distributed.

There may be at least two coils 2, such as flat-wire vertical-winding coils. Each of the coils 2 may be wound on one winding portion; in this regard, injection molding channels may be formed between the inner side surfaces of the coils 2 and the grooves on the winding portions. The injection molding channels may be used to fill a high-temperature plastic melt (such as a high temperature flowing melt of engineering plastics such as PPS).

The injection molding body 3 may be filled along the injection molding channels, so that it can form an integrally molded body together with the magnetic core 1 and the coils 2. This integrally molded body can minimize a spatial distance between the coils 2 and the magnetic core I to ensure good electrical insulation. Also, such extremely thin insulation distance can improve outward heat conduction of the magnetic core 1, and compact injection effect can ensure the resistance to mechanical vibration and impact of the overall inductive element. Of course, in addition to a body filled between the coils 2 and the magnetic core 1, the injection molding body 3 may also include a body wrapping outside the magnetic core 1, which is more conductive to the protection and installation of the overall inductive element.

In some embodiments, for the two winding portions arranged on the magnetic core 1, the grooves on the winding portions may be extended towards at least one end of the winding portions and be extended beyond the coverage of the coils on the winding portions, so that during injection molding the high-temperature plastic melt can be smoothly entered the injection molding channels along the grooves that are outside the coverage. In addition, the grooves can be extended vertically or curvilinearly on the winding portions, and the cross section of the grooves may be trapezoidal, arc or square. That is, there is no limit to the shape of the grooves in extension, as well as the shape of the grooves in cross section.

It shall be noted that, the grooves on the winding portions may inevitably change the shape of the cross section of the magnetic core, which will affect the magnetic flux density of the magnetic core. The depth and width of the grooves may be limited to change insignificantly the inductance characteristics and magnetic flux density, which can not only ensure that the cross section of the grooves is as small as possible, but also ensure that the injection molding can be achieved under low injection molding pressure. For example, the depth of the grooves is ranged between 1 mm and 5 mm, the width of the grooves is ranged between 3 mm and 15 mm, and a preset percentage of the area of any cross section of the winding portions is greater than the area of the cross section of one or more grooves.

In some embodiments, referring to FIGS. 1-5, the magnetic core I may be designed as an annular structure combined by a plurality of components, which is convenient for assembly. The magnetic core may include two first components (such as a first component 11 and a first component 12 shown in the figures) and a plurality of second components (such as a second component 13 and a second component 14 shown in the figures). The two first components 11, 12 may be arranged opposite to each other, the two second components 13, 14 may be arranged parallelly in two rows in parallel and between the two first components 11, 12, and all the first and second components may be combined to form the magnetic core 1 of the annular structure. It shall be noted that, the second components 13, 14 may be used as the winding portions, respectively, a coil 21 may be wound on the second component 13 and a coil 22 may be wound on the second component 14.

For example, all the first and the second components are combined to form the annular structure of the magnetic core 1. For details, referring to FIG. 5, the first components 11, 12 each have a U-shaped opening, and the plurality of second components (i.e. the second components 13, 14) are arranged in two rows in parallel and between the oppositely-disposed openings of the two first components, thus forming the annular structure in an arrangement of the first component 11, the second component 14, the first component 12 and the second component 13. Referring to FIG. 4 and FIG. 5, the second component 13 is provided with a groove 131, an injection molding channel 1311 is formed between the groove 131 and the coil 21; and the second component 14 is provided with a groove 141, an injection molding channel 1411 is formed between the groove 141 and the coil 22.

It shall be noted that for each of the second components 13, 14, its outer surface may include one or more geometric surfaces. A plurality of the geometric surfaces may be provided with grooves. Taking the magnetic core shown in FIG. 5 as an example, the second component 14 is a rectangular structure including six geometric surfaces, two of which need to be in clearance fit with the opening of the first component 11 and the opening of the second component 12 without need of coil winding; accordingly, there is unnecessary to provide a groove on the two geometric surfaces, while the remaining four geometric surfaces are used to be wound by the coils. In this regard, one or move grooves may be arranged on the four geometric surfaces, respectively. For example, in FIG. 4 and FIG. 5, grooves 131, 132 are arranged on the upper and lower sides of the second component 13, respectively, accordingly, the injection molding channel 1311 is formed between the groove 131 and the coil 21, and an injection molding channel 1321 is formed between the groove 132 and the coil 21; and grooves 141, 142 are arranged on the upper and lower sides of the second component 14, respectively, accordingly, the injection molding channel 1411 is formed between the groove 141 and the coil 22, and an injection molding channel 1421 is formed between the groove 142 and the coil 22.

Moreover, for the winding portions formed by each of the second components 13, 14, the grooves on the winding portions may be extended to the outer side of the first components, see FIGS. 3-5 for details. The groove 131 on the second component 13 is extended to the first component 11 to form a groove 111 on the first component 11, and the groove 131 on the second component 13 is extended to the first component 12 to form a groove 121 on the first component 12. The groove 141 on the second component 14 is extended to the first component 11 to form a groove 112 on the first component 11, and the groove 141 on the second component 14 is extended to the first component 12 to form a groove 122 on the first component 12. In this regard, after the first components 11, 12 and the second components 13, 14 are assembled, the grooves 111, 131, 121 form a connected channel and the grooves 112, 141, 122 form another connected channel.

It shall be noted that for the annular structure of the magnetic core 1, the material of the magnetic core 1 may be optimized to achieve better inductance characteristics and magnetic flux density. For example, the materials of the first components 11, 12 and the second components 13, 14 may be all made of metal powder, especially be made of pressed metal powder.

In some embodiments, since the magnetic core 1 is an annular structure formed by combining the first components 11, 12 and the second components 13, 14, the inductive apparatus may also include a plurality of fixed brackets (such as fixed brackets 41, 42) to realize a complete assembly among the components. Each of the fixed brackets may be fixedly around the corresponding first component and may be provided with a clamping component. The inner side of the clamping components may clamp the second components, and the outer side of the clamping components may carry the coils. Referring to FIGS. 1-4, the fixed bracket 41 provided with clamping components 411, 412 may be fixed on the first component 11, and the fixed bracket 42 provided with clamping components 421, 422 may be fixed on the first components 12. In this regard, the inner side of the clamping component 411 and the inner side of the clamping component 421 may clamp the two ends of the second component 13 respectively, and the outer side of the clamping component 411 and the outer side of the clamping component 421 may carry the two ends of the coil 21 respectively, thus fixing the second component 13 and the coil 21; correspondingly, the inner side of the clamping component 412 and the inner side of the clamping component 422 may clamp the two ends of the second component 14 respectively, and the outer side of the clamping component 412 and the outer side of the clamping component 422 may carry the two ends of the coil 22 respectively, thus fixing the second component 14 and the coil 22.

It shall be noted that there will be a large gap between the second component 13 and the first component 11 when they are in clearance fit, which will weaken the magnetic flux; accordingly, an air gap shim 15 made of a metal material may be arranged between the second component 13 and the first component 11 to enhance the magnetic flux. Similarly, an air gap shim 16 may be arranged between the second component 13 and the first component 12, an air gap shim 17 may be arranged between the second component 14 and the first component 11, and an air gap shim 18 may be arranged between the second component 14 and the first component 12, thus enhancing the magnetic flux of the entire magnetic core loop.

It shall be noted that with reference to FIGS. 1-4, since the fixed bracket 41 can fix the second components 13, 14 on its inner side and fix the coils 21, 22 on its outer side, injection molding gaps 134, 135, 136 can be formed between the inner side of the coil 21 and the outer side of the second component 13, and injection molding gaps 144, 135,136 can be formed between the inner side of the coil 22 and the outer side of the second component 14. Moreover, in order to ensure that the plastic melt can be smoothly flowed and filled in the injection molding gaps while meeting requirements for the injection molding gaps to be as narrow as possible, the gap distance of the injection molding gaps may be ranged between 0.5 mm and 3 mm. Additionally, in FIG. 1 and FIG. 4, since the injection molding gaps 134, 135, 136, 144 and the injection molding channels 1311, 1321, 1411, 1421 are communicated with each other, the injection molding body 3 can be expanded along the injection molding channels 1311, 1321, 1411, 1421 to the surrounding injection molding gaps 134, 135, 136, 144, thus filling the injection molding channels and the injection molding gaps.

In some embodiments, for each of the winding portions formed by the second component, the grooves on the winding portions may be extended to the outer side of the first components, and an injection molding inlet may be formed between the grooves extended on the first components and the fixed brackets fixedly surrounding it. The injection molding inlet may be communicated with the injection molding channel, so that the plastic melt can be injected into the injection molding channel through the injection molding inlet to form the injection molding body 3. See FIGS. 1-5 for details. The groove 131 on the second component 13 may be extended to the first component 11 to form the groove 111 on the first component 11, the groove 131 on the second component 13 may be extended to the first component 12 to form the groove 121 on the first component 12; the groove 141 on the second component 14 may be extended to the first component 11 to form the groove 112 on the first component 11, and the groove 141 on the second component 14 may be extended to the first component 12 to form the groove 122 on the first component 12. In this regard, the injection molding inlet may be formed among the groove 111, the groove 112 and the fixed bracket 41, respectively; and the injection molding inlet may be formed among the groove 121, the groove 122 and the fixed bracket 42, respectively.

In some embodiments, referring to FIG. 1 and FIG. 2, the injection molding body 3 may not only fill gaps among the magnetic core I and the coils 21, 22 along the injection molding channels to form filling parts 31, 32, but also wrap the first components 11, 12 to form assembly parts 33, 34 on the periphery of the first components 11, 12 respectively. The filling parts 31, 32 here are results of the plastic melt filling the injection molding channels and the injection molding gaps; and the assembly parts 33, 34 here are results of the plastic melt filling in an injection mold, and are mainly used to install and fix the integrally molded body composed of the injection molding body 3, the magnetic core 1 and the coils 21, 22. For example, the assembly parts 33, 34 may be provided with a plurality of through holes 35, 36 configured to pass through screws or bolts for installation and fixation. It shall be noted that the inductive apparatus can be fixed on some power equipment by passing the screws or bolts through the through holes 35, 36. For example, the assembly part 34 may also be provided with a plurality of screw holes 37, 38 configured to cooperate and fix a flat wire 5.

Further, referring to FIG. 1 and FIG. 2, the assembly part 34 may be also provided with the flat wire 5 which may be connected with terminals of the coils 2 to introduce or lead out direct current (DC) to the coils 2. For the coils 21, 22, two terminals of the coil 21 are 211, 212 respectively, and two terminals of the coil 22 are 221, 222 respectively, wherein the terminals 211, 221 are connected through a conducting wire 23, and the terminals 212, 222 are connected to the flat wire 5. The flat wire 5 may include a first wire 51 and a second wire 52 for inflow and outflow of DC respectively. The first wire 51 may be connected with the terminal 212, and the second wire 52 may be connected with the terminal 222. Of course, in order to stable connect the flat wire 5, the first wire 51 may be fixed on the assembly part 34 with the cooperation of a screw 53 and a screw hole 38, and the second wire 52 may be fixed on the assembly part 34 with the cooperation of a screw 54 and a screw hole 37.

In other embodiments, referring to FIG. 6, the magnetic core 1 may include the first components 11, 12 and a plurality of second components 13, 14; and all the first components and the second components may be combined to form the magnetic core 1 of the annular structure. The second component 13 may have two or more sub-components which are arranged in a row and distributed between the oppositely-disposed openings of the first components 11, 12; similarly, the second component 14 may also have two or more sub-components which are arranged in a row and distributed between the oppositely-disposed openings of the first components 11, 12. It shall be understood that designing a plurality of sub-components for the second components 13, 14 respectively can, on one hand, reduce the length of a single component and the volume of a single coil to facilitate assembly, and on the other hand, randomly adjust the magnetic flux of the magnetic core by decreasing or increasing the number of the sub-components so that the inductive apparatus can be used flexibly in practice.

### Embodiment 2

Referring to FIGS. 7-9, an inductive apparatus with another structure disclosed in this embodiment may mainly include a magnetic core 1, coils 2 and an injection molding body 3. The difference between the inductive apparatus in Embodiment 1 and that in this embodiment is the specific structure of the magnetic core 1 and that of the injection molding body 3.

The magnetic core 1 may include two first components 11, 12 arranged opposite to each other and two second components 13, 14 arranged in two rows in parallel between the two first components 11, 12. All the first components and the second components may be combined to form the magnetic core 1 of the annular structure.

It shall be noted that the second components 13, 14 here may be used as winding portions respectively; moreover, the winding portions may be provided with one or more grooves, the coil 21 may be wound on the second component 13 and the coil 22 may be wound on the second component 14. In this regard, an injection molding channel may be formed between the grooves on the second component 13 and the inner side of the coil 21, and an injection molding channel may also be formed between the grooves on the second component 14 and the inner side of the coil 22.

In this embodiment, refer to FIG. 8 and FIG. 9, the first components 11, 12 may both be of a flat structure. Different from the structure of the U-shaped opening shown in FIG. 5, provision of the flat structure is being convenient to process and assemble components. In addition, the second components may be arranged in two rows in parallel and between the oppositely-disposed openings of the two first components 11, 12, thus forming the annular structure in an arrangement of the first component 11, the second component 14, the first component 12 and the second component 13.

In this embodiment, refer to FIG. 8 and FIG. 9, for each of the second components 13, 14, its outer side may include six geometric surfaces, four of which may be provided with grooves. Taking the magnetic core shown in FIG. 9 as an example, for the second component 14, since its two geometric surfaces need to be in clearance fit with the openings of the first and second components 11, 12 without need of coil winding, the two geometric surfaces may not be provided with the grooves; and the remaining four geometric surfaces each may be provided with a groove, such as the grooves 141, 142, 143, 144, these grooves each may form an injection molding channel with the inner side of the coil 22, in this regard, the injection molding body 3 can be filled along these injection molding channels.

In this embodiment, for the winding portions formed by each of the second components 13, 14, the grooves on the winding portions may extend to the outer side of the first components. For example, the plurality of grooves on the second component 13 may be extended onto the first components 11, 12 respectively, and the plurality of grooves on the second component 14 may be extended onto the first component 11 and the first component 12 respectively; in this regard, the grooves on the first components 11, 12 may be connected to the injection molding channel between the second component 13 and the coil 21, as well as the injection molding channel between and the second component 14 and the coil 22. Accordingly, it is easy to inject high-temperature plastic melt to the injection molding channels.

In this embodiment, since the magnetic core 1 is an annular structure formed by assembling the first components 11, 12 and the second components 13, 14, the inductive apparatus in this embodiment may also include a plurality of fixed brackets (such as fixed brackets 43, 44, 45, 46) to achieve complete assembly between the components. Each fixed bracket may be composed of four clamping components which are assembled at the four corners of one end of the second component so as to clamp the second component inwards and bear the coil outwards. As shown in FIG. 8, the fixing brackets 43, 45 may clamp the second component 13 and carry the coil 21, and the fixing brackets 44, 46 may clamp the second component 14 and carry the coil 22.

It shall be noted that since the fixed brackets 43, 44, 45, 46 can fix the second components 13, 14 on the inner side and fix the coils 21, 22 on the outer side, an injection molding gap may be formed between the inner side of the coil 21 and the outer side of the second component 13, and an injection molding gap may be formed between the inner side of the coil 22 and the outer side of the second component 14. In this regard, the injection molding body 3 can be expanded along the injection molding channels to the surrounding injection molding gaps, so as to fill the injection molding channels and the injection molding gaps.

It shall be noted that for the structures of the magnetic core and the coils, a bare inductance structure composed of a U-shaped yoke magnetic core (or a strip magnetic core with square middle column) and two coils may be used. The yoke magnetic core may also be a flat-panel block yoke magnetic core, and the shape of the strip magnetic core may be of cylindrical, oval and other shapes. Of course, the coils may also be of a single-coil structure and a multi-coil structure.

### Embodiment 3

Referring to FIG. 5, FIG. 6 and FIG. 9, a combined powder magnetic core disclosed in this embodiment may include two first components (such as first components 11, 12) and a plurality of second components (such as second components 13, 14). The two first components 11, 12 may be arranged oppositely, and the second components 13, 14 may be arranged in two rows in parallel and between the two first components 11, 12.

For the second components 13, 14, each second component can form the winding portion which is provided with one or more grooves. It shall be noted that the winding portion may be used to be wound by the coil so that the injection molding channel is formed between the inner side of the coil and the grooves on the winding portion.

It shall be noted that all the first components and the second components are combined to form the annular structure which can generate an electromagnetic loop when the coils are energized.

In this embodiment, for the winding portions formed by the second components 13, 14 respectively, the grooves on the winding portions may be extended to at least one of the two ends of the winding portions and extended beyond the coverage of the coils on the winding portions. For example, in FIG. 5, the groove 131 on the second component 13 may be extended from one end of the geometric surface to the other end, and the groove 141 on the second component 14 may be extended from one end of the geometric surface to the other end. It shall be understood that such extension allows the high-temperature plastic melt to be easily entered the injection molding channel smoothly along the grooves outside the coverage during injection molding.

It shall be understood that the grooves may be extended vertically or curvilinearly on the winding portions, and the cross section of the grooves may be trapezoidal, arc or square; that is, there is no limit herein to the shape of the grooves in extension and the shape of the grooves in cross section. In addition, the grooves on the winding portions may inevitably change the cross-sectional shape of the magnetic core, which will affect the magnetic flux density of the magnetic core. The depth and width of the grooves may be limited so as to insignificantly change the inductance characteristics and magnetic flux density; in this respect, the cross section of the grooves can be as small as possible, and the injection molding can be completed under a small injection molding pressure. For example, the depth of the grooves is ranged between 1 mm and 5 mm, and the width of the grooves is ranged between 3 mm and 15 mm. In addition, a preset percentage of the area of any cross section of the winding portions may be greater than the area of the cross section of the one or more grooves.

In some embodiments, the second components 13, 14 each may be provided with a fixing part which is configured to surround and fix a preset fixed bracket for clamping the first component. In addition, the grooves of the winding portions on the second components may be extended to the first components, and an injection molding inlet may be formed between the grooves on the first components and the fixed brackets fixedly therearound. The injection molding inlet here is connected with the injection molding channel; and the plastic melt can be injected into the injection molding channel through the injection molding inlet to form the injection molding body. For example, as shown in FIG. 3 and FIG. 5, the opening positions of the second components 13, 14 may be provided with fixing parts on which the fixing brackets 41, 42 can be fixed, so that the fixed brackets 41, 42 can clamp the second components 13, 14 internally and can carry the coils 21, 22 externally. Moreover, the groove 131 on the second component 13 may be extended to the first component 11 to form the groove 111 on the first component 11, the groove 131 on the second component 13 may be extended to the first component 12 to form the groove 121 on the first component 12, the groove 141 on the second component 14 may be extended to the first component 11 to form the groove 112 on the first component 11, and the groove 141 on the second component 14 may be extended to the first component 12 to form the groove 122 on the first component 12.

In this embodiment, for the annular structure of the magnetic core 1, the material of the magnetic core 1 can be optimized to achieve better inductance characteristics and magnetic flux density. For example, the materials of the first components 11, 12 and the second components 13, 14 are all made of metal powder, especially made of pressed metal powder.

### Embodiment 4

Referring to FIG. 10, an injection molding method for an inductive apparatus provided in the present disclosure may mainly include steps 610-650 described below respectively.

Step 610: providing a magnetic core, a plurality of coils and an injection mold.

The magnetic core may be of an annular structure and may have two winding portions. Each winding portion may be provided with one or more grooves, such as the magnetic core 1 in FIG. 2, FIG. 3, FIG. 5 and FIG. 6. The grooves on the winding portions may be extended to at least one of both ends of the winding portions and extended beyond the coverage of the coils on the winding portions, so that the high-temperature plastic melt can smoothly enter the injection molding channel along the grooves outside the coverage during injection molding. In addition, the grooves may be extended vertically or curvilinearly on the winding portions, and the cross section of the grooves may be of trapezoidal, arc or square. In addition, the depth of the grooves may be ranged between 1 mm and 5 mm, and the width of the grooves may be ranged between 3 mm and 15 mm. The preset percentage of the area of any cross section of the winding portions may be greater than the area of the cross section of the one or more grooves.

There may be at least two coils, such as flat-wire vertical-winding coils. Each of the coils may be wound on one corresponding winding portion. For details, refer to the coils 21, 22 in FIGS. 2-6.

The injection mold may be a tool for producing an integrated inductive apparatus, and may comprise a combination of a plurality of parts. A molding cavity may be formed inside the combination. During injection molding, the injection mold may be clamped on an injection molding machine; plastic melt (such as high-temperature flowing melt of engineering plastics such as PPS) may be injected into the molding cavity and be cooled and shaped in the cavity; the mold may then be opened to remove a product from the molding cavity; and the injection mold may be closed again for next injection molding. Accordingly, the entire process of injection molding can be recycled.

Step 620: wrapping the coils on the winding portions to form an injection molding channel between the inner side of the coils and the grooves on the winding portions. It shall be understood that the coils may be either temporarily wound on the winding portions, or pre-wound to be assembled on the winding portions, which is not strictly limited here.

For example, in FIG. 4 and FIG. 5, the coil 21 is wound on the winding portion formed by the second component 13, and the coil 22 is wound on the winding portion formed by the second component 14. For example, pre-wound coils 21, 22 may be directly assembled on corresponding winding portions. Since the second component 13 is provided with the groove 131, an injection molding channel 1311 is formed between the groove 131 and the coil 21; and since the second component 14 is provided with the groove 141, an injection channel 1411 is formed between the groove 141 and the coil 22.

Step 630: placing the magnetic core wound with the coils into the injection mold. It shall be noted that the cavity of the injection mold may be of a specific shape, which can accommodate the magnetic core wound with coils, and the shape of the cavity may determine which parts of the magnetic core and coils are filled for injection molding and which parts are not filled for injection molding.

Step 640: injecting plastic melt into the injection mold to allow the plastic melt to fill in the injection molding channel. During injection molding, certain injection molding pressure may also be applied to the plastic melt, so that the plastic melt can completely fill the injection molding channel between the inner side of the coils and the grooves on the winding portions.

Step 650: cooling the plastic melt in the injection mold to form an injection molding body which can form an integrally molded body together with the magnetic core and the coils. For example, in FIG. 1 and FIG. 2, the injection molding body 3 can be obtained after a structure composed of the magnetic core 1 and the coils is injected.

In this embodiment, referring to FIGS. 1-6, the magnetic core 1 may include two first components 11, 12 and a plurality of second components 13, 14. The two first components 11, 12 are arranged opposite to each other; the second components 13, 14 are arranged in two rows in parallel and between the two first components 11, 12; all the first components and the second components are combined to form the annular structure of the magnetic core 1; and the second components 13, 14 are used as the winding portions.

The first components 11, 12 may be respectively surrounded by fixed brackets 41, 42, the fixed bracket 41 may be provided with clamping components 411, 412, the fixed bracket 42 may be fixed at the first component 12 and provided with clamping components 421, 422; in this regard, the inner side of the clamping component 411 and the inner side of the clamping component 421 may clamp two ends of the second component 13 respectively, and the outer side of the clamping component 411 and the outer side of the clamping component 421 may carry two ends of the coil 21, thus fixing the second component 13 and coil 21. Correspondingly, the inner side of the clamping component 412 and the inner side of the clamping component 422 may clamp two ends of the second component 14 respectively, and the outer side of the clamping component 412 and the outer side of the clamping component 422 may carry two ends of the coil 22, thus fixing the second component 14 and coil 22. In addition, an injection molding gap may be formed between the inner side of the coil 21 and the outer side of the second component 13, and an injection molding gap may be formed between the inner side of the coil 22 and the outer side of the second component 14.

Since the formed injection molding gaps and the injection molding channels are connected with each other, during injecting the plastic melt into the injection mold, the plastic melt can be expanded to surrounding injection molding gaps in the injection molding channels until the injection molding channels and the injection molding gaps are filled.

For example, as shown in FIGS. 1-3, the injection molding body 3 can not only fill the gaps among the magnetic core 1 and the coils 21, 22 along the injection molding channels to form the filling parts 31, 32. The filling parts 31, 32 here are results of the plastic melt filling the injection molding channels and the injection molding gaps. Moreover, the injection molding body 3 may also include the first components 11, 12, the peripheries of which form the assembly parts 33, 34. The assembly parts 33, 34 here, results of the plastic melt filling the injection mold, are configured to install and fix the integrally molded body produced by the injection molding body 3, the magnetic core 1 and the coils 21, 22.

It shall be noted that high-power inductive apparatus mainly use oil cooling or water cooling for heat dissipation of components to reduce the volume and cost thereof. Accordingly, for the design of the inductive apparatus of the present disclosure, after completing the injection molding of the inductive apparatus, the outer surfaces of the coils, as the hottest part, may need to be fully exposed. Through the exposed surfaces of the coils to conduct heat dissipation externally is one of the most effective means to improve the heat dissipation of the inductance and reduce the volume of the inductance. It shall be understood that in order to realize the exposure of the coils, an integrated plastic injection inlet may need to be arranged at one or both sides of the inductive coils; and upon different products, the injection inlet may be used to inject from one side or from both the left and right sides. Additionally or alternatively, the magnetic core and the coils may be assembled and arranged in advance in the injection mold by the fixed brackets on both sides of the coils. During the injection molding, high-temperature plastic melt such as PPS may be injected from the inlets at the outside of the fixed brackets, then flowed quickly in the injection molding channels along the inside of the coils, and filled the gaps between the magnetic core and the coils, thus completing one-piece injection molding.

The present disclosure is described and illustrated by means of the above specific examples to only help understand the technical solution of the present disclosure, and not to limit thereto. For those skilled in the art, a number of simple deduction, deformation or replacement can also be made according to the idea of the present disclosure.

1. An injection molded inductive apparatus, comprising a powder magnetic core, a coil and an injection molding body, wherein,
the powder magnetic core comprising two first components and a plurality of second components; wherein:
the two first components are arranged opposite to each other,
the plurality of second components are arranged in two rows in parallel and between the two first components, the second components forming winding portions provided with at least one groove, wherein a depth of the at least one groove is ranged between 1 mm and 5 mm, and a width of the at least one groove is ranged between 3 mm and 15 mm,
the winding portions are configured to be wound by a coil, the inner side of the coil and the at least one groove on the winding portions forms an injection molding channel,
all the first components and the second components are assembled to form an annular structure that generates an electromagnetic loop when the coil is energized,
wherein the at least one groove on the winding portions are extended to at least one end of the winding portions and extended beyond a coverage of the coil on the winding portions,
wherein the second components are provided with fixing parts configured to surround and fix preset fixed brackets for claiming the first components,
the at least one groove on the winding portions of the second components are extended to the first components, the at least one groove extended on the first components and the fixed brackets fixedly therearound form an injection molding inlet; and
the injection molding inlet is connected with the injection molding channels, and plastic melt is capable of being injected to the injection molding channels through the injection molding inlet to form an injection molding body;
the coil is wound on the winding portions, and an injection molding channel is formed between an inner side of the coil and the at least one groove on the winding portions; and
the injection molding body is filled in the injection molding channels and constitutes an integrally molded body together with the powder magnetic core and the coil.

2. (canceled)

3. The inductive apparatus according to claim 1, wherein the at least one groove is extended vertically or curvilinearly on the winding portions, and a cross section of the at least one groove is trapezoidal, arc or square.

4. (canceled)

5. (canceled)

6. The inductive apparatus according to claim 1, wherein the first components have U-shaped openings; and the second components are arranged in two rows in parallel and between two oppositely-arranged openings of the first components.

7. The inductive apparatus according to claim 1, wherein an outer side surface of the second components comprises one or more geometric surfaces, and some of the geometric surfaces are provided with grooves.

8. The inductive apparatus according to claim 1, further comprising
a plurality of fixed brackets fixedly surrounding the first components; and
the fixed brackets are provided with clamping components, an inner side of the clamping components clamping the second components and an outside of the clamping components carrying the coils.

9. The inductive apparatus according to claim 8, wherein injection molding gaps are formed between the inner side of the coil and an outer side of the second components, a gap distance of the injection molding gaps being ranged between 0.5 mm and 3 mm; and
the injection molding body is expanded to the injection molding gaps therearound along the injection molding channels, filling the injection molding channels and the injection molding gaps.

10. (canceled)

11. The inductive apparatus according to claim 1, wherein the injection molding body wraps the first components, forming assembly parts on a periphery of the first components; and
the assembly parts are configured to install and fix an integrally molded body formed by the injection molding body, the powder magnetic core and the coil.

12. The inductive apparatus according to claim 11, wherein the assembly parts are provided with a plurality of through holes configured to pass through screws or bolts used for installation and fixation.

13. The inductive apparatus according to claim 11, wherein the assembly parts are further provided with a flat wire connected with a terminal of the coil to introduce or lead out direction current to the coil.

14. A combined powder magnetic core, comprising two first components and a plurality of second components; wherein:
the two first components are arranged opposite to each other;
the plurality of second components are arranged in two rows in parallel and between the two first components, the second components forming winding portions provided with at least one groove, wherein a depth of the at least one groove is ranged between 1 mm and 5 mm, and a width of the at least one groove is ranged between 3 mm and 15 mm;
the winding portions are configured to be wound by a coil, the inner side of the coil and the at least one groove on the winding portions forms an injection molding channel;
all the first components and the second components are assembled to form an annular structure that generates an electromagnetic loop when the coil is energized;
wherein the at least one groove on the winding portions are extended to at least one end of the winding portions and extended beyond a coverage of the coil on the winding portions;
wherein the second components are provided with fixing parts configured to surround and fix preset fixed brackets for claiming the first components;
the at least one groove on the winding portions of the second components are extended to the first components, the at least one groove extended on the first components and the fixed brackets fixedly therearound form an injection molding inlet; and
the injection molding inlet is connected with the injection molding channels, and plastic melt is capable of being injected to the injection molding channels through the injection molding inlet to form an injection molding body.

15. (canceled)

16. (canceled)

17. The powder magnetic core according to claim 14, wherein of the first components and the second components are made of materials of metal powder, and are made of pressed metal powder.

18. An injection molding method for forming the powder magnetic core according to claim 14, the method comprising:
providing a powder magnetic core, a plurality of coils and an injection mold, the powder magnetic core being of an annular structure and provided with two winding portions provided with at least one groove;
winding the coils onto the winding portions so that an injection molding channel is formed between an inner side of the coils and the at least one groove on the winding portions;
arranging the powder magnetic core surrounded by the coils in the injection mold;
injecting plastic melt into the injection mold so as to fill the plastic melt along the injection molding channel; and
cooling the plastic melt in the injection mold to form an injection molding body that is capable of forming an integrally molded body together with the powder magnetic core and the coils.

19. (canceled)
